(19) United States
(12) Patent Application Publication
(10) Pub. No.: US 2016/0086505 A1
(43) Pub. Date: Mar. 24, 2016

(54) SYSTEM FOR ASSESSING USER KNOWLEDGE ABOUT A HEALTHCARE SYSTEM

(71) Applicant: Robert F. Hanlon, Chaska, MN (US)

(72) Inventor: Robert F. Hanlon, Chaska, MN (US)

(21) Appl. No.: 14/492,316

(22) Filed: Sep. 22, 2014

(51) Int. Cl. G09B 7/08; G09B 7/07; G09B 19/00; G09B 19/18; G09B 23/28

(52) U.S. Cl. CPC G09B 7/08; G09B 19/18; G09B 23/28; G09B 19/00; G09B 7/07

(57) ABSTRACT

A method of providing access to a web site includes providing access to a plurality of assessment questions through the web site. The plurality of assessment questions relate to user knowledge regarding interaction with and navigation through a healthcare system. The plurality of assessment questions are arranged in a pre-determined sequential order including, in order: pre-event assessment questions including assessment questions on educational topics that assess the knowledge of the user on how to interact with the healthcare system before a healthcare event occurs; active event assessment questions including assessment questions on educational topics that assess the knowledge of the user on how to interact with the healthcare system during the occurrence of a healthcare event; and post-event assessment questions including assessment questions on educational topics that assess the knowledge of the user on how to interact with the healthcare system after one or more healthcare events has occurred.

### BACKGROUND

The healthcare system in the United States is complex and is difficult for some individuals to understand and use efficiently and effectively. Considering all the choices an individual may need to make, from finding a doctor, to dealing with insurance companies, to understanding treatment options when sick, the individual may sometimes be overwhelmed and not know how to proceed. Considering the need to understand nutrition and good health practices to attempt to prevent health issues, individuals may feel even more overwhelmed. In addition, changes in the healthcare system increase the number and complexity of decisions an individual may need to make.

Many individuals receive healthcare coverage through employer provided healthcare plans. Healthcare coverage is expensive and is a major expense for a business. Typically, the more healthcare that is used, the more the business and individuals need to pay. This is especially true for businesses that are self-insured.

When employees are knowledgeable, healthy and happy, they may have less of a need to use the healthcare system. However, some employees may not understand how to use the healthcare system and may not make the best decisions because they do not know how the system works. Whereas lower employee use of the healthcare system may result in lower healthcare costs for the business, most employees will typically need to use the healthcare system at some point in their lives.

Teaching people how to use the healthcare system before they need to may be a catalyst for reducing healthcare costs both in the present and in the future. Assessing people's knowledge of the healthcare system may identify areas of knowledge for which people may be deficient and may help provide more effective ways of teaching people how to use the healthcare system.

### SUMMARY

The present disclosure relates generally to an assessment, training and outcomes based measurement system. In some embodiments, and by non-limiting example, the disclosure relates to an assessment, training and outcomes based measurement system for measuring user knowledge about how to use a healthcare system.

In one aspect, a method of assessing user knowledge on a healthcare system comprises: providing access to a web site using one or more server computing devices; providing access to a plurality of assessment questions through the web site, the plurality of assessment questions relating to user knowledge regarding interaction with and navigation through a healthcare system, the plurality of assessment questions being arranged in a pre-determined sequential order including, in order: pre-event assessment questions including assessment questions on one or more educational topics that assess the knowledge of the user on how to interact with the healthcare system before a healthcare event occurs; active event assessment questions including assessment questions on one or more educational topics that assess the knowledge of the user on how to interact with the healthcare system during the occurrence of a healthcare event; and post-event assessment questions including assessment questions on one or more educational topics that assess the knowledge of the user on how to interact with the healthcare system after one or more healthcare events has occurred.

In another aspect, a method for accessing knowledge of a healthcare system for employees of a business comprises: providing healthcare system assessment questions to the employees in a predetermined order, the healthcare system assessment questions being provided from a server computer through a website; compiling results from the assessment questions; providing a personalized training plan to the employees based on the results; making content available through the website to train the employees on healthcare system topics associated with the personalized training plan; providing quizzes related to the healthcare system topics; compiling results from the quizzes; and using the results of the quizzes to evaluate the effectiveness of the personalized training plans.

In yet another aspect, a server computer comprises a processing unit; and memory, the memory storing instructions that, when executed by the processing unit, cause the server computer to: host a web site that provides a plurality of educational topics and that provides a plurality of assessment questions relating to the educational topics; provide access to the plurality of assessment questions through the web site, the plurality of assessment questions relating to user interaction with and navigation through a healthcare system, the plurality of assessment questions being arranged in a pre-determined sequential order including, in order: pre-event assessment questions including assessment questions on one or more educational topics that educate the user on how to interact with the healthcare system before a healthcare event occurs, the pre-event assessment questions including questions on financial information on how to fund healthcare when the healthcare event occurs, and questions on managing healthcare records generated during a healthcare event; active event assessment questions including assessment questions on one or more educational topics that educate the user on how to interact with the healthcare system during the occurrence of a healthcare event, the active event assessment questions including: questions relating to assist the user in verifying an illness; questions relating to assist the user in selecting treatment options; questions relating to assist the user in selecting a healthcare professional; questions relating to assist the user while the user is a patient; and questions relating to assist the user when treatment ends; and post-event information including assessment questions on one or more educational topics that educate the user on how to interact with the healthcare system after one or more healthcare events has occurred, the post-event assessment questions including questions on managing prescriptions and information on payment of a bill for the healthcare event; compile results from the assessment questions; provide a summary of the results to the user through the website; provide a personalized training plan for the user based on the compiled results, the personalized training plan including a recommendation of one or more of the educational topics for the user to review, the recommendation of the one or more educational topics for the user to review being based on the user's score; provide quizzes related to each of the recommended educational topics; and provide access to the quizzes through the website; and compile results from the quizzes.

### BRIEF DESCRIPTION OF THE DRAWINGS

FIG. 1 shows an example healthcare system environment.

FIG. 2 shows example engines of the assessment system of FIG. 1.

FIG. 3 shows example healthcare system training modules associated with the pre-treatment assessment engine of FIG. 2.

FIG. 4 shows example healthcare system training modules associated with the treatment assessment engine of FIG. 2.

FIG. 5 shows example healthcare system training modules associated with the post-treatment assessment engine of FIG. 2.

FIG. 6 shows an example home page user interface screen for a training and assessment system website.

FIG. 7 shows an example user interface screen for a first assessment question.

FIG. 8 shows an example user interface screen showing assessment question results.

FIG. 9 shows an example user interface screen for healthcare navigation training.

FIG. 10 shows an example user interface screen for choosing a healthcare champion.

FIG. 11 shows an example user interface screen for reading about experiences of others.

FIG. 12 shows an example user interface screen for a care card.

FIG. 13 shows an example flowchart for a method of providing assessment questions to a user regarding interacting with and navigating through the healthcare system.

FIG. 14 shows an example flowchart for an operation from FIG. 13 for making assessment questions available to a user through a website.

FIG. 15 shows an example sequential order of assessment questions.

FIG. 16 shows example physical components of the web server of FIG. 1.

### DETAILED DESCRIPTION

The healthcare system is largely based on numerous policies, procedures, and best-practices that define how the various parties involved with the healthcare system should act in certain circumstances. The parties include, of course, the healthcare providers, such as physicians and other caregivers, and the patient. But the healthcare system also includes numerous other parties, including health insurance companies, healthcare administrators, medical supply and medical device manufacturers, and the like.

The policies and procedures are designed for the masses, but cannot address the unique circumstances of each patient. The policies and procedures of the healthcare system therefore often lead to improper or unnecessary medical care, for example. A patient or healthcare advocate, who is trained to understand the healthcare system and at least some of these policies and procedures, can be empowered to engage with the system and adjust the processes to beneficially impact costs and outcomes.

Businesses have an interest in having healthy and happy employees. By educating employees about healthcare, businesses may help their employees to be happier, healthier and more productive. In addition, employee healthcare costs for the business may be reduced.

When businesses educate employees about healthcare, employees generally need to be aware of a need to learn about healthcare and be motivated to learn about healthcare. Generally employees are motivated to learn when they have a need to learn, for example when they have a health issue that they need to deal with, and when they understand that there may be some areas relating to healthcare for which their knowledge may be lacking. However, some employees may not be aware that they are deficient in knowledge regarding healthcare.

From a business point of view, a process for educating employees regarding healthcare may be more efficient when specific employees who may benefit from the knowledge are identified. An employee who is motivated to learn may be more receptive to training.

Identifying employees who may be deficient in knowledge of certain topics of the healthcare system or who may have a medical condition for which training or more education may be beneficial can sometimes be challenging. For many employees, their own healthcare issues are private matter with which they may not want to share with their employers. In addition, privacy laws may prevent employers from directly asking employees questions regarding the employee's health status and knowledge regarding the healthcare system.

The present disclosure is directed to a system and methods for assessing employees' knowledge of the healthcare system and assessing their knowledge of interacting with and navigating through the healthcare system. The systems and methods are directed to assessing the employees' knowledge in a non-threatening way in which the privacy of the employee is preserved.

In an example embodiment, employee assessments are conducted electronically via a web-based assessment system in which employees can be assessed online over the Internet. In some embodiments, assessment system questions are arranged into categories. For example, in some embodiments the assessment system questions are arranged in categories including: pre-event questions, active event questions, and post-event questions. In some embodiments the questions are presented in a sequential order. As one example, the questions are presented in order of pre-event questions, active event questions, and post-event questions.

Examples of the pre-event questions include questions for one or more of: an introduction to the healthcare system, healthcare champions, funding an individual's healthcare, managing health information, staying healthy and preparing for emergencies. Examples of the active-event questions include questions for one or more of: verifying an individual's illness, selecting treatment options, selecting a healthcare provider, being a patient, when treatment ends and coordinating care for the patient. Examples of the post-event questions include questions for one or more of: managing chronic disease, managing prescriptions, paying the final bill and long-term care. In this disclosure, the pre-event questions, active event questions and post-event questions may also be referred to as pre-treatment questions, treatment questions and post-treatment questions, respectively.

The assessment system questions are related to training modules that may be used to train and educate the employees for navigating the healthcare system. In this example embodiment the training modules for navigating the healthcare system include modules relating to 1) an introduction to the healthcare system, 2) healthcare champions, 3) funding an individual's healthcare, 4) managing health information, 5) staying healthy, 6) verifying an illness, 7) selecting treatment options, 8) selecting a healthcare provider, 9) being a patient, 10) when treatment ends, 11) coordinating care for the patient, 12) managing chronic disease, 13) managing prescriptions, 14) paying the final bill, 15) preparing for emergencies and 16) long-term care.

Employee answers to the assessment questions are scored electronically and individual training programs are suggested to the employees based on the scores. The individual training programs are generally associated with the training modules. For example, if an employee scores low on questions related to one or more training modules, the individual training program may include a suggestion to review the one or more training modules in which the employee missed a related assessment question. In addition, employees may request training sessions with a health risk consultant. These training sessions are typically small group training sessions.

After an employee has completed an individual training program, the employee may be tested on the content of the training modules that the user has completed. Quizzes are provided at the end of the training modules to test the user's knowledge of the content provided in the training modules. In some embodiments, the user may also take a post-assessment to determine whether the user has applied information learned from the individual training program.

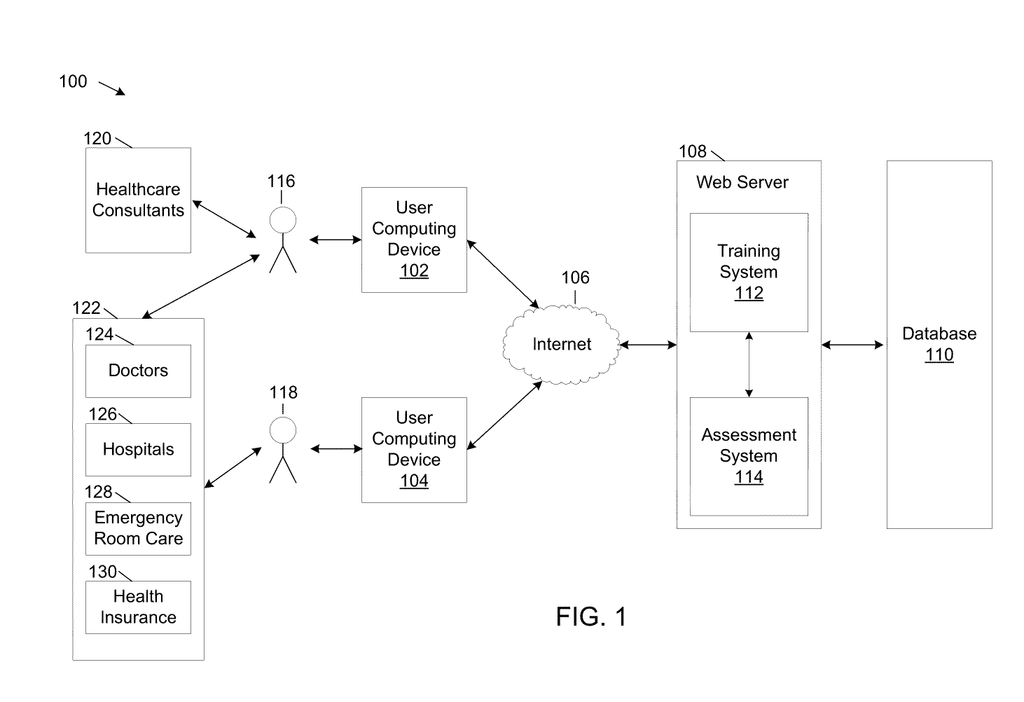

FIG. 1 illustrates an example healthcare system environment 100 according to the present disclosure. The healthcare system environment 100 includes one or more healthcare systems, such as the healthcare system 122, which provides care to users and may also provide payment for the healthcare provided by the healthcare system 122. Often the healthcare system involves numerous laws, regulations, contractual provisions, and procedures that need to be navigated by both the user and the care providers.

The healthcare system environment 100 also includes a training system 112 that operates to educate the users 116,118 on aspects of the healthcare system 122. Once educated, the users 116,118 can more easily navigate through the healthcare system 122. An example of the training system 112 is discussed in detail in U.S. patent application Ser. No. 13/968,960, “Training System for Educating Users About a Healthcare System,” filed Aug. 16, 2013, the disclosure of which is hereby incorporated by reference in its entirety.

The healthcare system environment 100 also includes an assessment system 114 that operates to provide assessment questions to the users 116, 118 regarding user knowledge of aspects of the healthcare system 122. The assessment system 114 also scores users answers to the assessment questions and compiles personalized training programs for the users 116, 118 based on the user scores.

In the example illustrated in FIG. 1, the healthcare system environment 100 includes user computing devices 102, 104, data communication network 106, web server 108, database 110 and training system 112. More or fewer user computing devices, web servers, and databases may be used. In some embodiments, one or more mobile computers, for example tablet computers and smart telephones, may be used.

The healthcare system environment 100 also includes healthcare system users 116, 118, healthcare consultants 120, and an example healthcare system 122. In the example healthcare system environment 100, user 116 is an employee of a business and user 118 is an individual user.

A business user 116 on user computing device 102 or an individual user 118 on user computing device 104 may access a training system website from user computing device 102 or user computing device 104, respectively. A user interface for the training system website is received from web server 108 via the data communication network 106, and rendered on user computing device 102 or on user computing device 104. An example of the network 106 is the Internet, which may include multiple different data communication networks that operate together to permit data communication through and between the various networks. As discussed in detail later herein, the user interface permits business user 116 and individual user 118 to access one or more assessment modules.

The web server 108 includes training system 112 and assessment system 114. In some embodiments, the training system 112 operates to educate the user 116, 118 through a series of training modules. Training module information may be stored on web server 108, on database 110 or on a combination of web server 108 and database 110. In some embodiments, the assessment system 114 operates to question the user 116, 118 regarding knowledge of the user 116, 118 on aspects of the healthcare system 122. The assessment system 114 interfaces with the training system 112. Questions presented to the user 116, 118 are associated with specific training modules in the training system 112.

A business may also make use of healthcare consultants 120. The healthcare consultants 120 are life services consultants hired by the business to organize and help implement the training system 112 and/or the assessment system 114 at the business. The healthcare consultants 120 are typically trained and knowledgeable in healthcare issues and in the operation of the training system 112 and/or the assessment system 114. The healthcare consultants 120 may teach onsite classes on the training modules, may help answer employee questions, may recruit and train healthcare champions at the business. The healthcare consultants 120 may also provide training sessions for the training modules as part of a personalized training program for the employees of the business. Other uses of the healthcare consultants 120 are possible.

When the business user 116 and the individual user 118 learn the content of the training modules, the business user 116 and individual user 118 may be better able to navigate and use the healthcare system 122. As shown in FIG. 1, the healthcare system 122 includes, for example, doctors 124, hospitals 126, emergency room care 128 and health insurance 130. Other aspects of the healthcare system are possible and are not shown in FIG. 1.

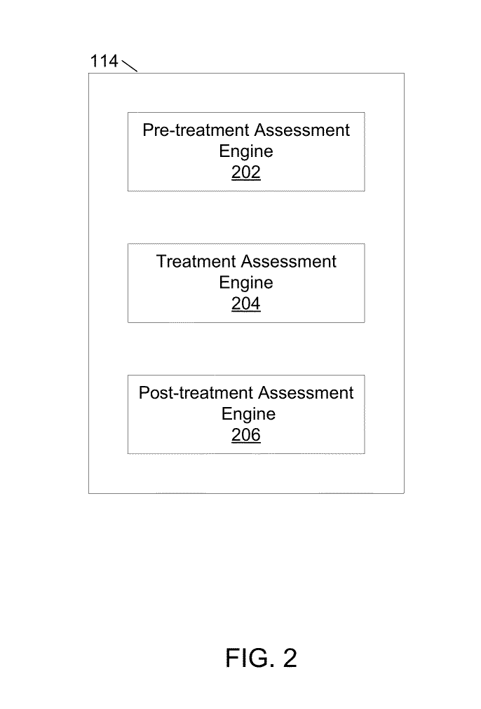

FIG. 2 shows example engines of the assessment system 114. The example engines include a pre-treatment assessment engine 202, a treatment assessment engine 204 and a post-treatment assessment engine 206. The pre-treatment assessment engine 202 provides questions relating to healthcare system pre-treatment events. The treatment assessment engine 204 provides questions relating to healthcare system active events and the post-treatment assessment engine 206 provides questions relating to healthcare system post-treatment events.

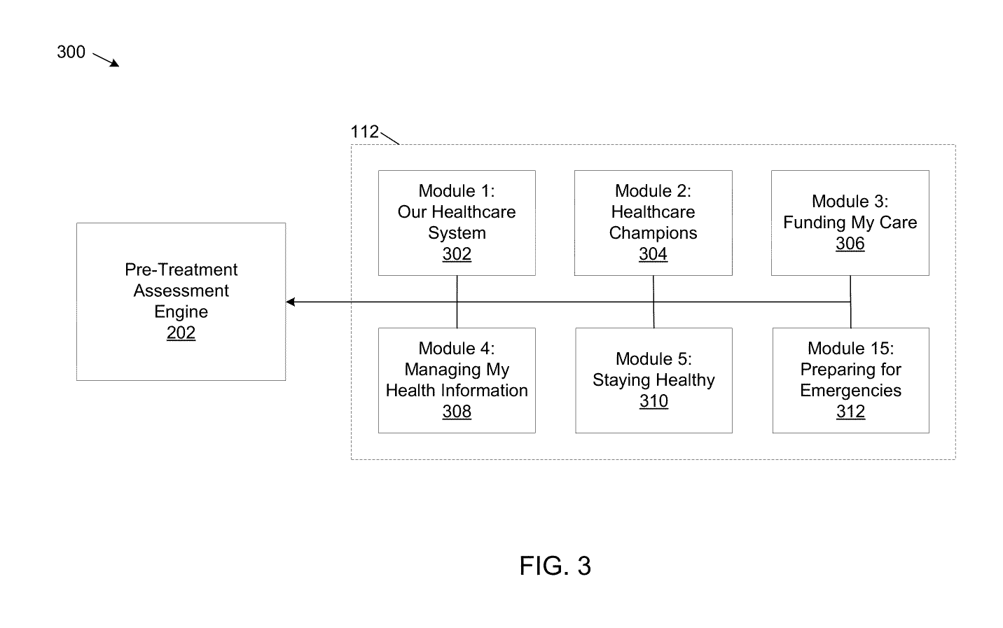

FIG. 3 shows example healthcare system modules to which the pre-treatment assessment engine 202 is related. The healthcare system modules to which the pre-treatment assessment engine 202 is related include the healthcare system 302, healthcare champions, 304, funding my care 306, managing my healthcare information 308, staying healthy 310 and preparing for emergencies 312.

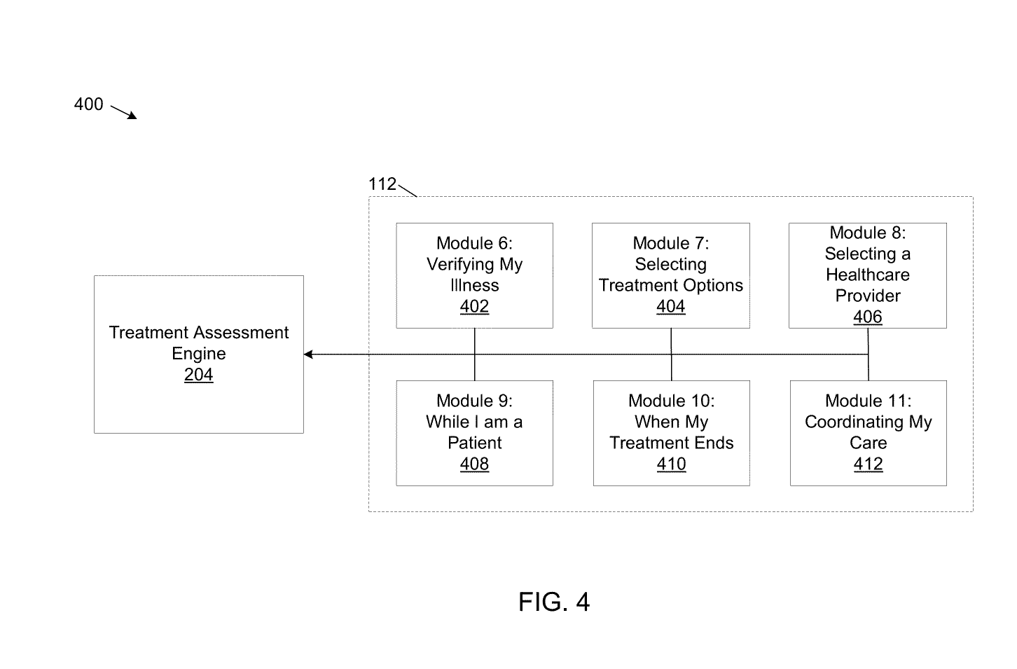

FIG. 4 shows example healthcare system modules to which the treatment assessment engine 204 is related. The healthcare system modules to which the treatment assessment engine 204 is related include verifying my illness 402, selecting treatment options 404, selecting a healthcare provider 406, while I am a patient 408, when my treatment ends 410 and coordinating my care 412.

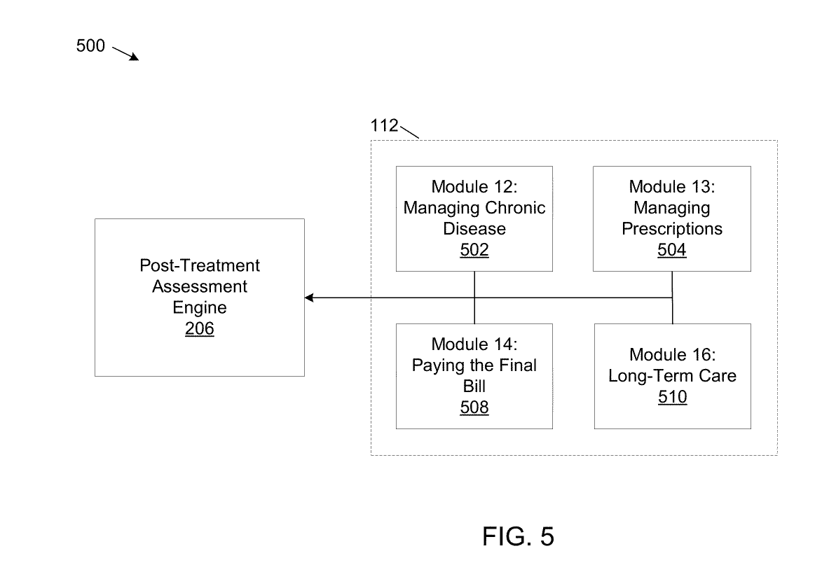

FIG. 5 shows example healthcare system modules to which the post-treatment assessment engine 206 is related. The healthcare system modules to which the post-treatment assessment engine 206 is related includes managing chronic disease 502, managing prescriptions 504, paying the final bill 508 and long-term care 510.

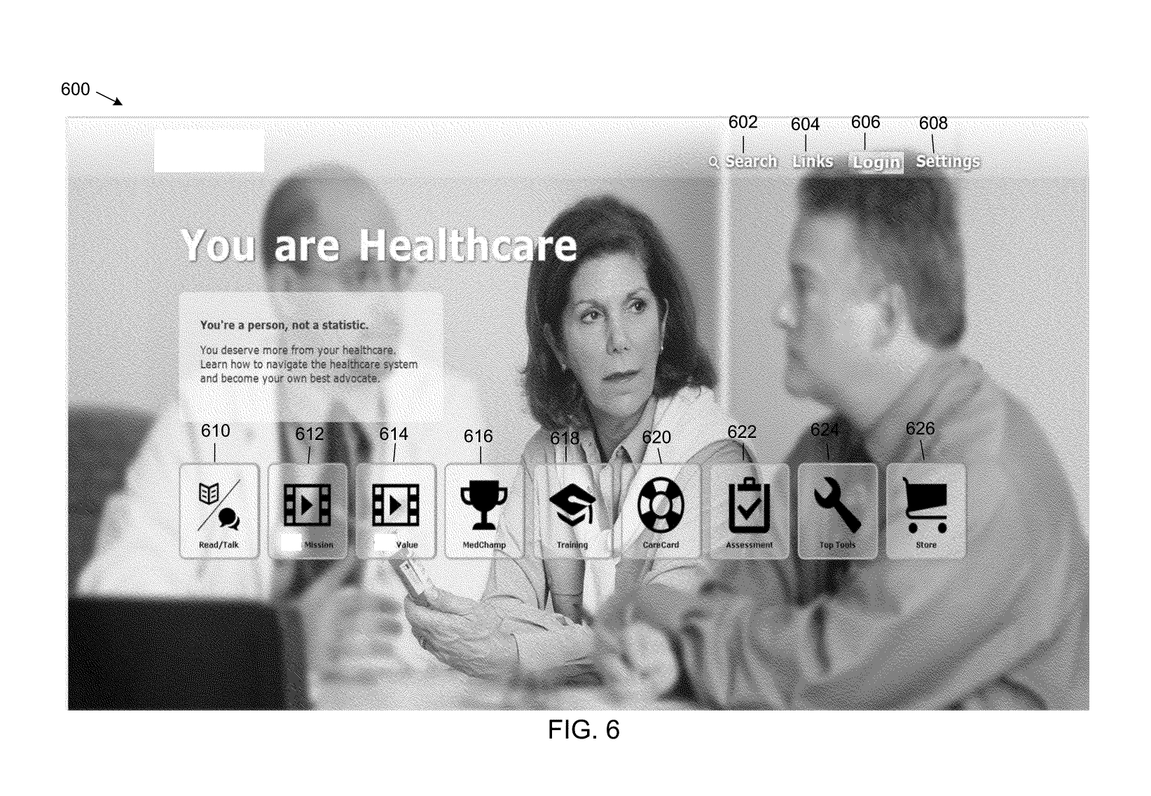

FIG. 6 shows an example user interface screen 600 that may be displayed when the business user 116 or the individual user 118 accesses the training and assessment system website rendered by web server 108. The following discussion describes actions taken by business user 116 on user computing device 102. These actions may also apply to individual user 118 on user computing device 104.

The user interface screen 600 permits a user to login to the training and assessment website and to access training, assessment and other healthcare related web pages. The user interface screen 600 includes selectors for search 602, links 604, login 606 and settings 608. When the user selects search 602, a search box is displayed permitting the user to search for specific topics in the training and assessment website. When the user selects links 604, a drop down menu of specific links is displayed. Example links that the user can select include services, partners, blog, contact, calendar and about us. When the user selects login 606 a login user interface is displayed, permitting the user to enter a username or email and a password so that the user can login to the training and assessment website. When the user selects settings 608, a settings user interface is displayed, permitting the user to update specific settings such as the user's password, the user's email address and the user's name.

The user interface screen 600 also includes icons for read/talk 610, mission 612, value 614, medchamp 616, training 618, carecard 620, assessment 622, top tools 624 and store 626. When one of these icons is selected, a specific user interface screen corresponding to the icon is displayed. The user interface screen for assessment 622 is described first, herein. Typically, the user logs in to the training and assessment website, via selecting login 606 and entering a user name/email address and password, before selecting the assessment 622 icon.

When the user clicks the assessment 622 icon, a first of a plurality of assessment questions is displayed on the display screen of user computing device 102 or user computing device 104. Each of the assessment questions is multiple choice.

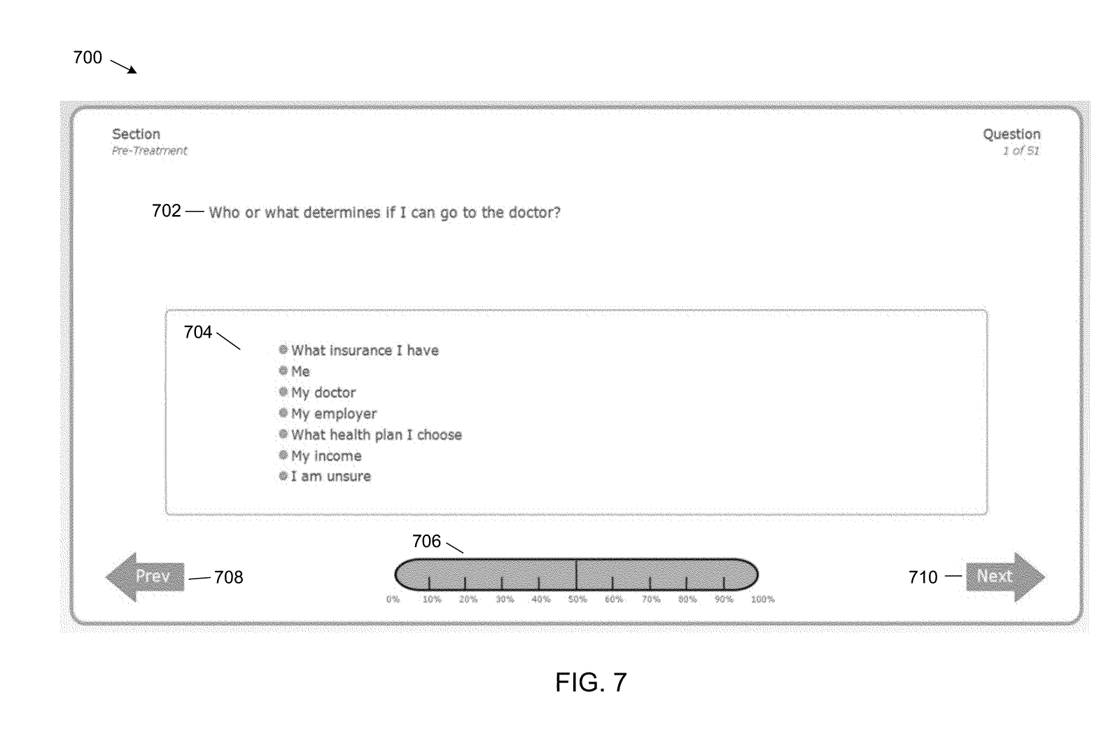

A user interface screen 700 for the first example assessment question is shown in FIG. 7. As shown in FIG. 7, the first assessment question 702 “Who or what determines if I can go to the doctor?” is from the pre-treatment assessment questions. For question 702, seven multiple choice answers 704 are provided. In this example, the seven answer choices are “What insurance I have”, “Me”, “My doctor”, “My employer”, “What health plan I choose”, “My Income”, and “I am unsure.” The user selects an answer by clicking on a circle to the left of each answer. Only one answer may be selected. For question 702, the correct answer is “Me.” For other questions, more or fewer multiple choice answers may be provided.

The user interface screen 700 also includes a progress bar 706, a previous arrow 708 and a next arrow 710. The progress bar 706 indicates a percent completion for the assessment questions. Clicking the next arrow 710 brings up a display of the next assessment question, in this case question 2.

All succeeding assessment questions have the same format as user interface screen 700—a question, multiple choice answers, a progress bar and previous and next arrows. The following tables 1-3 list the assessment question and answer choices.

Table 1 provides examples of pre-treatment assessment questions and multiple choice answers. The pre-treatment assessment questions test a user's knowledge of healthcare modules relating to: 1) the healthcare system, 2) healthcare champions, 3) funding my care, 4) managing my health information, 5) staying healthy and 15) preparing for emergencies. Question numbers in table 1 correspond to question numbers presented to the user.

TABLE 1
Pre-Treatment Assessment Questions and Answer Choices
Module 1: The Healthcare System

| | |
|---|---|
| 1 | Who or what determines if I can go to the doctor? |

What insurance I have
Me
My employer
What health plan I choose
My income
I am unsure

| | |
|---|---|
| | (Answer: B) |
| 2 | Which best describes the standard U.S. Healthcare System? |

Fee for service
Pre-paid
Universal health care
Nationalized health care
I am unsure

| | |
|---|---|
| | (Answer: A and B) |
| 3 | When you interact with healthcare in the U.S., what things are the most |
| | important to consider? |

Who I pay and the care I receive
Who bills me and who decides if I get care
Who helps pay and who decides what care I get
Who decides how much I pay and the quality of my care
I am unsure

(Answer: A)

Module 2: Healthcare Champions

| | |
|---|---|
| 4 | A healthcare champion is best described as? |

A person who knows a lot about healthcare
Someone who is willing, and has the ability, to help manage my
healthcare and health
A doctor or medical professional
A person who works at the doctor's office, clinic, or hospital
I am unsure

| | |
|---|---|
| | (Answer : B) |
| 5 | Who cannot be my healthcare champion? |

Family member
Busy friend
Me
Someone I hire
A medical professional
I am unsure

| | |
|---|---|
| | (Answer: B) |
| 6 | What attributes will you need to have to be a healthcare champion for a family |
| | member or friend? |

Dedicated to their well-being and willing to learn whatever is necessary
to help
Dependable and patient
Availability, time in your schedule
Access to a phone and computer
I am unsure

(Answer: all of them)

Module 3: Funding My Care

| | |
|---|---|
| 7 | Which of the following is the most important thing to pay attention to if you |
| | want to reduce your overall medical financial risk? |

Annual deductible
Annual co-insurance
Prescription co-pay
Annual out-of-pocket
I am unsure

| | |
|---|---|
| | (Answer: D) |
| 8 | The premium I must pay to have health insurance is mostly based on? |

Government taxes
Insurance company profits
How much medical care used
The amount of claims paid
Regular inflation rates
I am unsure

| | |
|---|---|
| | (Answer: C and D) |
| 9 | Who is ultimately responsible for paying my healthcare bill? |

Me
My insurance carrier
My doctor
The hospital
Medicare or Medicaid
I am unsure

| | |
|---|---|
| | (Answer: A) |
| 10 | What is important for you to prepare financially for health expenses? |

Have a health insurance policy in place
Reserve a credit card just to be used for health expenses
Save any extra income, i.e. tax return money to be used for health
expenses
Put money in a health savings account (if possible) or save money
specifically for health expenses
I am unsure

(Answer: A and D)

Module 4: Managing My Health Information

| | |
|---|---|
| 11 | Who is responsible for making sure the information in my health record is |
| | accurate? |

The medical facility
The doctor who treated me
My health insurance company
I am
I am unsure

| | |
|---|---|
| | (Answer: D) |
| 12 | Which of the following are personal health record (PHR) services? |

Google Health
Microsoft Healthvault
My provider may offer a PHR service
My carrier may offer a PHR service
I am unsure

| | |
|---|---|
| | (Answer: all of them) |
| 13 | What should you not do with your health information? |

Access my health information on my own
Provide trusted people access to my health information
Publish it online in a social media site
Share my health information with another medical professional
I am unsure

(Answer: C)

Module 5: Staying Healthy

| | |
|---|---|
| 14 | What preventive care services must be covered by your insurance? |

Alcohol abuse screenings and counseling
Blood pressure screenings in adults
Cholesterol screenings for adults in certain age ranges or at high risk
Depression screenings in adults
I am unsure

| | |
|---|---|
| | (Answer: all of them) |
| 15 | Getting preventive care will end up costing more money - true or false? |

True
False
I am unsure

| | |
|---|---|
| | (Answer: False) |
| 16 | If you have health insurance, certain preventive services for everyone are |
| | covered 100% - true or false? |

True
False
I am unsure

| | |
|---|---|
| | (Answer: True) |
| 17 | How should you decide which preventive care you should receive? |

My insurance policy covers the particular service
My health policy renews shortly, so I need to get it done
It is too late, I already feel sick
Follow the AMA Preventive Medical Guide
Ask my doctor
I am unsure

(Answer D and E)

Module 15: Preparing for Emergencies

| | |
|---|---|
| 18 | What is the best way for most of us to be properly prepared for health |
| | emergencies? |

Keep a well-stocked first aid kit
Become CPR, first-aid and AED certified
Take a nursing class at your local community college
Become an Emergency Medical Technician
I am unsure

| | |
|---|---|
| | (Answer: A and B) |
| 19 | What should you do until emergency help arrives? |

Call 911
Try to administer any first aid that was instructed by the dispatcher
Search for any medical history or records the injured person may have at
home
Stay by the door to let paramedics inside
Gather the person's medications into a bag to give to the paramedics
I am unsure

| | |
|---|---|
| | (Answer: all of them) |
| 20 | What should you do first when communicating with emergency personnel in a |
| | stressful situation? |

Let them know my relationship to the patient
Tell them all of the medical information I know about the patient
Describe what the patient and I were doing before the emergency
Let them know if I have any emergency situation training
I am unsure

(Answer: B)

Table 2 provides examples of treatment assessment questions. The treatment assessment questions test a user's knowledge of healthcare modules relating to: 6) verifying my illness, 7) selecting treatment options, 8) selecting a healthcare provider, 9) while I am a patient, 10) when my treatment ends and 11) coordinating my care.

TABLE 2
Treatment Assessment Questions and Answer Choices
Module 6: Verifying My Illness

| | |
|---|---|
| 21 | What are the top two reasons to get a second opinion? |

Satisfy my family members
My medical insurance insists upon it
To confirm my diagnosis
Abide by healthcare reform laws
To make sure I am comfortable before getting treatment
I am unsure

| | |
|---|---|
| | (Answer: C and E) |
| 22 | What is the first step to make sure your second opinion will be covered by your |
| | insurance? |

Ask the physician who gave the first opinion
Ask the physician giving the second opinion
Contact my insurance company to find out whether or not they pay for
second opinions
Ask my healthcare champion
Ask my attorney
I am unsure

| | |
|---|---|
| | (Answer: C) |
| 23 | What is the definition of “Iatrogenesis”? |

Form of healing
Cell formation in the body
A rare blood disease
Preventable harm from improper medical treatment or advice
I am unsure

(Answer: D)

Module 7: Selecting Treatment Options

| | |
|---|---|
| 24 | What should you do to prepare for an appointment with your doctor? |

Come prepared to answer questions about my medical history
Bring a “medical resume” or health history
Know the medications I am taking
Conduct some simple research on my own to learn more about my
symptoms
Read my doctor's bio
I am unsure

| | |
|---|---|
| | (Answer: all of them) |
| 25 | In 2014, according to Consumer Reports and The Journal of Patient Safety, how |
| | many people die each year from medical errors while in the hospital? |

```
    5,700
  43,987
  440,000
1,367,950
I am unsure
```

| | |
|---|---|
| | (Answer: C) |
| 26 | According to the Kaiser Family Foundation as reported in the Harvard School of |
| | Public Health, if a medical error occurs, what are the chances that it will get |
| | reported to the proper channels? |

```
  2.0%
  5.22%
  15%
80.76%
  100%
I am unsure
```

(Answer: B)

Module 8: Selecting a Healthcare Provider

| | |
|---|---|
| 27 | When you feel you should see a doctor in a non-emergency situation, which |
| | should occur first? |

Figure out how I am going to pay the bill
Know what type of doctor I need to visit
Just call the nearest doctor
Do nothing and wait until it gets worse
I am unsure

| | |
|---|---|
| | (Answer: B) |
| 28 | Which of the following would be the most reliable places to research healthcare |
| | professionals and/or facilities (i.e. clinics and hospitals) before you make a |
| | selection? |

Google search
Library
Insurance carrier's website
Angie's list
Friends and family
I am unsure

| | |
|---|---|
| | (Answer: C) |
| 29 | You can set up an informational interview with your potential new doctor. |

True
False
I am unsure

(Answer: True)

Module 9: While I am a Patient

| | |
|---|---|
| 30 | What are the top three things you can do to prepare for your doctor |
| | appointments or hospital stays? |

Contact my family, friends and co-workers
Know my medical history
Wait until I create a will
Ask questions until I feel comfortable
Have clear goals and know my priorities
I am unsure

| | |
|---|---|
| | (Answer: B, D and E) |
| 31 | If you feel your medical professional diagnosed your condition properly and |
| | recommended surgery, what should you do? |

Wait to see if my condition gets worse
Do what the doctor ordered and have surgery
Determine if there is any alternative to surgery and select an alternative
Determine all options for my condition and make a decision I feel most
comfortable with
I am unsure

| | |
|---|---|
| | (Answer: D) |
| 32 | When talking to your doctor, which is the best approach? |

Let the doctor do most of the talking and just listen to what they tell me
to do
I do more of the talking, and the doctor should listen to me
Learn how to ask more questions when my doctor recommends
something
Be prepared to discuss my symptoms, not what I think my condition is
I am unsure

| | |
|---|---|
| | (Answer: B, C and D) |
| 33 | While I'm in the hospital and I'm unhappy with my care, what should I do? |

Hope for the best
Do nothing
Keep complaining to your nurse
Leave
Ask to meet with the attending hospitalist
I am unsure

(Answer: E)

Module 10: When My Treatment Ends

| | |
|---|---|
| 34 | When you leave your doctor's office with a diagnosis and instructions, what |
| | should you do first? |

Do what the doctor told me to do even though I am unsure about their
recommendation
Wait to see if my symptoms get worse before taking action
Determine whether or not I feel comfortable with my doctor's diagnosis
Listen to my friend
I am unsure

| | |
|---|---|
| | (Answer: C) |
| 35 | When you are discharged from a hospital, what is the most important thing to |
| | do? |

Go home
Make sure I have a hospital discharge plan, and I understand it
Call my local doctor to let them know I am home
Make a return appointment
I am unsure

| | |
|---|---|
| | (Answer: B) |
| 36 | While you are a patient, which of the following mistakes could have the most |
| | serious impact? |

Not paying the bill
Not identifying a healthcare champion
Leaving without having a designated driver home
Leaving without proper medical instructions or ignoring them
I am unsure

(Answer: D)

Module 11: Coordinating My Care

| | |
|---|---|
| 37 | Which statements best describe what “coordination of care” means? |

My medical providers treat me at the same time
My medical providers know what they are doing
My medical file follows me from doctor to doctor during my care
My doctor knows what other treatments I had for my current illness to
help minimize cost and improve outcomes
I am unsure

| | |
|---|---|
| | (Answer: C and D) |
| 38 | Which of the following most closely relates to coordinating your own medical |
| | care? |

Pick my health advocate
Verify my illness and what medical professionals need to be involved
with my care
Identify which doctors I will see, and make sure they have all the
necessary medical information about me
Take a health information class
Get my finances in order
Purchase health insurance
I am unsure

| | |
|---|---|
| | (Answer: C) |
| 39 | Who is ultimately responsible to make sure there is consistent communication |
| | with all medical team members? |

My healthcare advocate
My primary care physician
I am
My insurance carrier
All of the above
I am unsure

(Answer: C)

Table 3 provides examples of post-treatment assessment questions. The post-treatment assessment questions test a user's knowledge of healthcare modules relating to: 12) managing chronic disease, 13) managing prescriptions, 14) paying the final bill and 16) long-term care.

TABLE 3
Post-Treatment Assessment Questions
Module 12: Managing Chronic Disease

| | |
|---|---|
| 40 | If you get a phone call from your insurance company about a visit to the doctor |
| | or a possible health issue, why are they trying to contact you? |

To keep me out of the hospital
They want to keep tabs on me
To make sure they don't lose money
To help me and make sure I get the best type of treatment regardless of
cost
To track my behavior and how much medical care I am using
I am unsure

| | |
|---|---|
| | (Answer: D) |
| 41 | Which of the following information or services can you find on your insurance |
| | company's website? |

Copies of my explanation of benefits
“Select a provider” tools
Information on types of claims
Information about how to talk to a nurse about my care
There is no useful information for me on my carrier's website
I am unsure

| | |
|---|---|
| | (Answer: A, B, C, D) |
| 42 | Which of the following are resources to help you manage the cost of a chronic |
| | condition? |

My local bank
Government Insurance Programs such as Medicaid and/or Medicare
My community public health department
My insurance provider
I am unsure

(Answer: B, C and D)

Module 13: Managing Prescriptions

| | |
|---|---|
| 43 | You have verified which medication you are taking, called your carrier to find |
| | out if it is included on the formulary, and asked if there is a generic alternative. |
| | What is the next step when shopping for a prescription? |

Call all my neighborhood pharmacies to compare costs
Call my insurance carrier's customer service line
Check online pharmacies to compare costs
Ask my provider
Talk to my pharmacists
I am unsure

| | |
|---|---|
| | (Answer: all of them) |
| 44 | What is the definition of a generic medication? |

A medication that can be purchased without a prescription
A medication comparable to brand name medications in dosage form,
strength, route of administration, quality, performance characteristics,
and intended use
A less expensive medication
A less effective medication
A regular medication
I am unsure

| | |
|---|---|
| | (Answer: B) |
| 45 | Is it possible to reduce your intake of prescription medication by changing your |
| | lifestyle? |

True
False
I am unsure

(Answer: True)

Module 14: Paying the Final Bill

| | |
|---|---|
| 46 | You or your insurance carrier must pay your provider whatever they bill? |

True
False
I am unsure

| | |
|---|---|
| | (Answer: False) |
| 47 | Is it OK to ask your provider for a discount before you pay your bill? |

Yes
No
I am unsure

| | |
|---|---|
| | (Answer: Yes) |
| 48 | Before getting care, you requested a cost estimate. After your care, you have |
| | now received a bill directly from your medical provider. What is the next step |
| | to secure the lowest cost when paying your bill? |

Pay the amount on the invoice
Check and compare my EOB from my insurance company to make sure
the billed amount is the negotiated rate and then pay my provider
Check and compare my EOB from my insurance company to make sure
the billed amount is the negotiated rate and then call my provider to
negotiate final payment
Make sure I have adequate funds available to pay my bill
Simply call my provider to try and negotiate a lower rate and then pay
Find out the CPT codes for my procedure
I am unsure

(Answer: C)

Module 16: Long-Term Care

| | |
|---|---|
| 49 | Long-term care is designed to help in which situation? |

Help support a person's illness if custodial in nature or when continued
medical care will not enhance their outcome
When people are older and need assistance
When I need to go into a nursing home
When I am young and have no health problems
If I become disabled
I am unsure

| | |
|---|---|
| | (Answer: A, B, C and E) |
| 50 | Which of the following help you determine when you or a loved one needs long- |
| | term care? |

Suffering from a chronic illness
Suffering from long-term injuries or disabilities
Seniors who may need assistance with certain everyday tasks
I am unsure

| | |
|---|---|
| | (Answer: all of them) |
| 51 | Which of the following are options for covering the costs associated with long- |
| | term care? |

Health insurance
Long-term care insurance
Short and long-term disability insurance
Property and casualty insurance
I am unsure

(Answer: B and C)

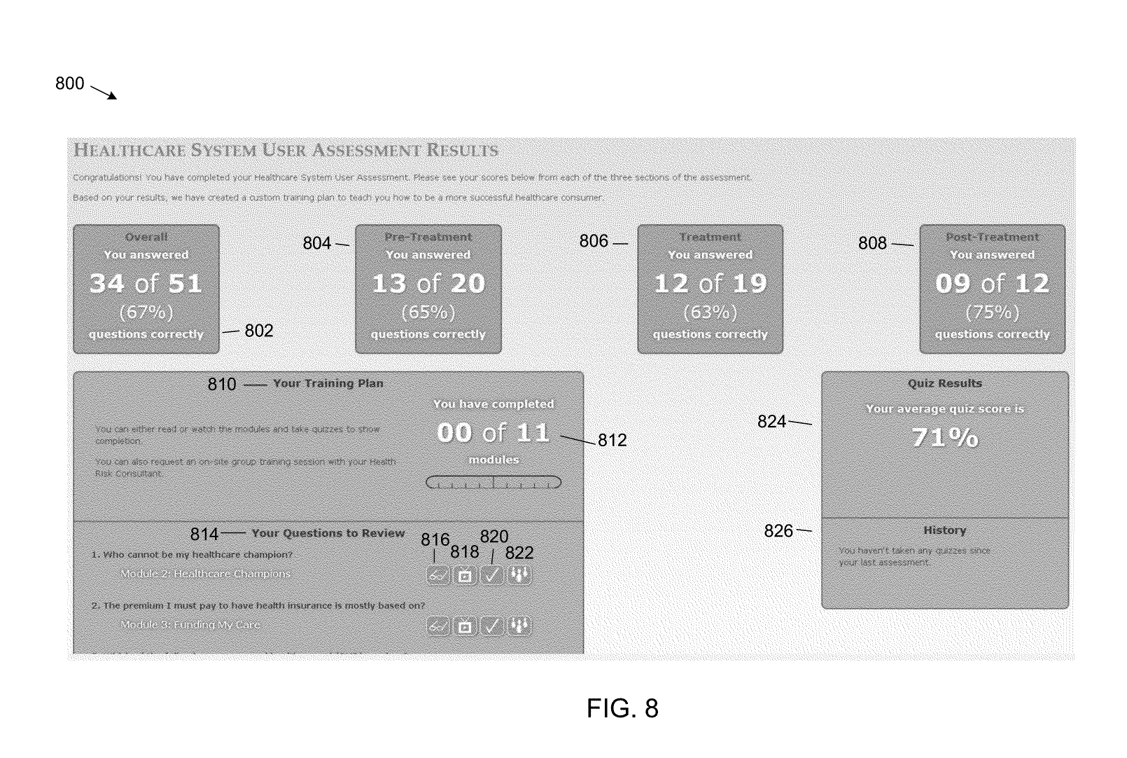

FIG. 8 shows a user interface screen 800 showing example healthcare system user assessment results. The user interface screen 800 includes an overall results summary 802, a results summary of pre-treatment section questions 804, a results summary of treatment section questions 806 and a results summary of post-treatment section questions 808. As shown in FIG. 8, the user answered 67% of all questions correctly including 65% of pre-treatment section questions, 63% of treatment section questions and 75% of post-treatment section questions.

Based on the results summaries, the assessment system 114 creates a training plan for the user. The training plan is designed to help the user review subject matter corresponding to questions that the user answered incorrectly. The training plan 810 is customized for the user and includes training modules for the user to review. Options are provided for the user to read or watch the modules, to take quizzes on subject matter in the module or to request an on-site group training session with a health risk consultant.

The example training plan 810 includes questions 814 for the user to review. Each question corresponds to a specific training module. In this embodiment, each question corresponds to a question that the user answered incorrectly during the health care assessment. For example, the first question in the training plan “Who cannot be my healthcare champion?” corresponds to module 2: Healthcare Champions. Each training module is associated with four icons, representing how the user wants to review the training module. Icon 816 is selected when the user wants to read the contents of the training module, icon 818 is selected when the users wants to watch a video of the training module, icon 820 is selected when the user wants to take a quiz of the training module and icon 822 is selected when the user wants to request an on-site group training session with a healthcare risk consultant. Each icon has a visual representation of a training method associated with the icon. Thus, icon 816 includes a pair of eyeglasses that represent reading, icon 818 includes a television screen that represents watching a video, icon 820 includes a checkmark that represents taking a quiz and icon 822 includes a group of people that represents a group training session.

The training plan 810 also includes a summary area 812 indicating the number of modules in the training plan, the number of modules completed and a progress bar showing percent completion. The user interface screen 800 also includes a quiz results summary 824 that indicates an average of the user's quiz scores and a history summary 826 that shows quizzes taken since the last assessment that the user completed.

In some embodiments, the user may also take a post-assessment evaluation. The post-assessment evaluation is a follow-up evaluation that may be given to the user when a sufficient time period has elapsed, for example one year, after the user completes the training modules. The post-assessment evaluation measures whether the user has applied the information learned in the training modules. The post-assessment evaluation can also be repeated annually, or at some other time interval. An example post-assessment evaluation form is provided in Appendix A.

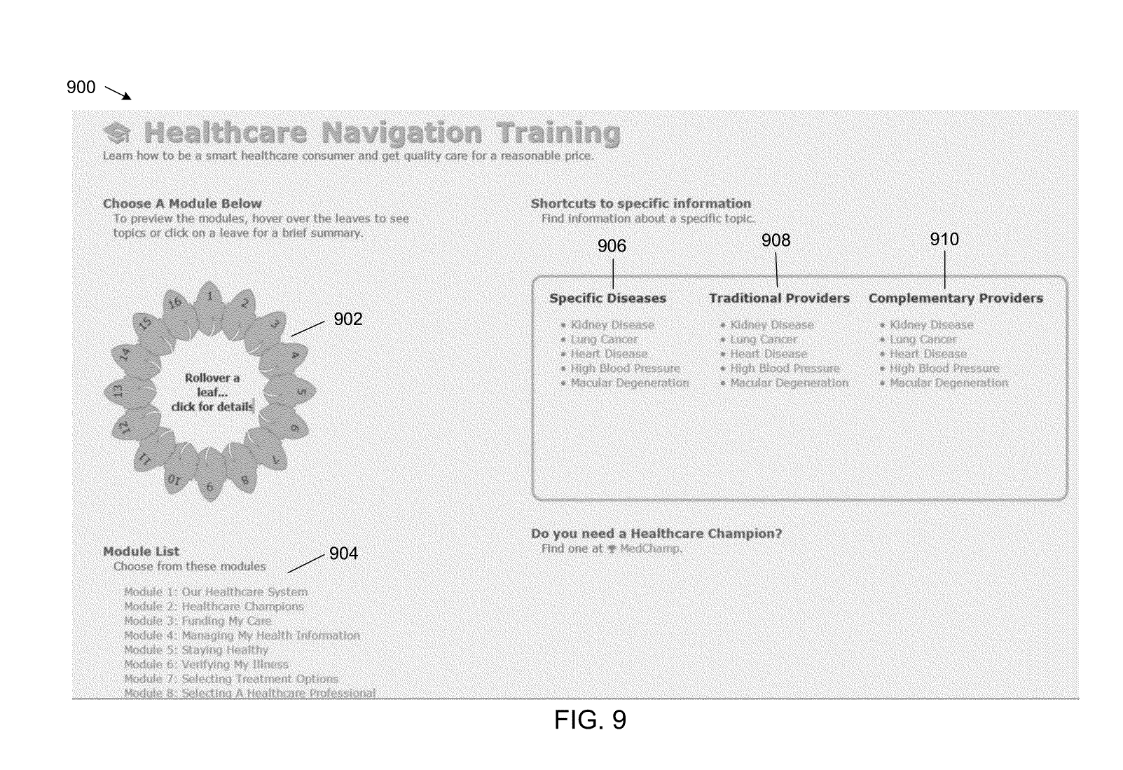

FIG. 9 shows an example user interface screen 900 for healthcare navigation training. The user interface screen 900 is displayed when the training icon 618 is selected on the user interface screen 600. The user interface screen 900 permits the user to access training modules that may be used as part of user's training plan or that may be used at any time whenever the user wants to learn about a healthcare subject covered in the training modules. As discussed in detail in U.S. patent application Ser. No. 13/968,960, the training modules cover various aspects of using the healthcare system. Each training module may be selected from a leaf display 902 or from a module list 904. In addition, the user interface screen provides shortcuts to specific information. For example hyperlinks 906 are provided for information on specific diseases, hyperlinks 908 are provided for specific disease information from traditional providers and hyperlinks 910 are provided for specific disease information from complementary providers.

In addition to the training modules, the training system 112 provides tools that may provide additional healthcare information to users. The tools may be accessed by selecting the top tools 624 icon from the user interface screen 600. The tools include information documents, checklists, quizzes and similar documents. Each tool is associated with a topic of a training module. For example, a tool associated with module 4 (Managing My Health Information) may include a list of items to include in a personal health care record. Tools associated with module 6 (Verifying My Illness) may include a list of reasons for deciding when to obtain a second opinion and when not to obtain a second opinion, a list of questions to ask a physician when obtaining a second opinion, and a guide to fund and prepare for a second opinion. Other examples of tools include knowing if you are ready to leave the hospital, and a list of questions to ask a pharmacist. A full list of example available tools that may be used in training system 112 is provided in Appendix B. Other tools not listed in Appendix A may also be used. Examples of selected tools are provided in Appendices C through R.

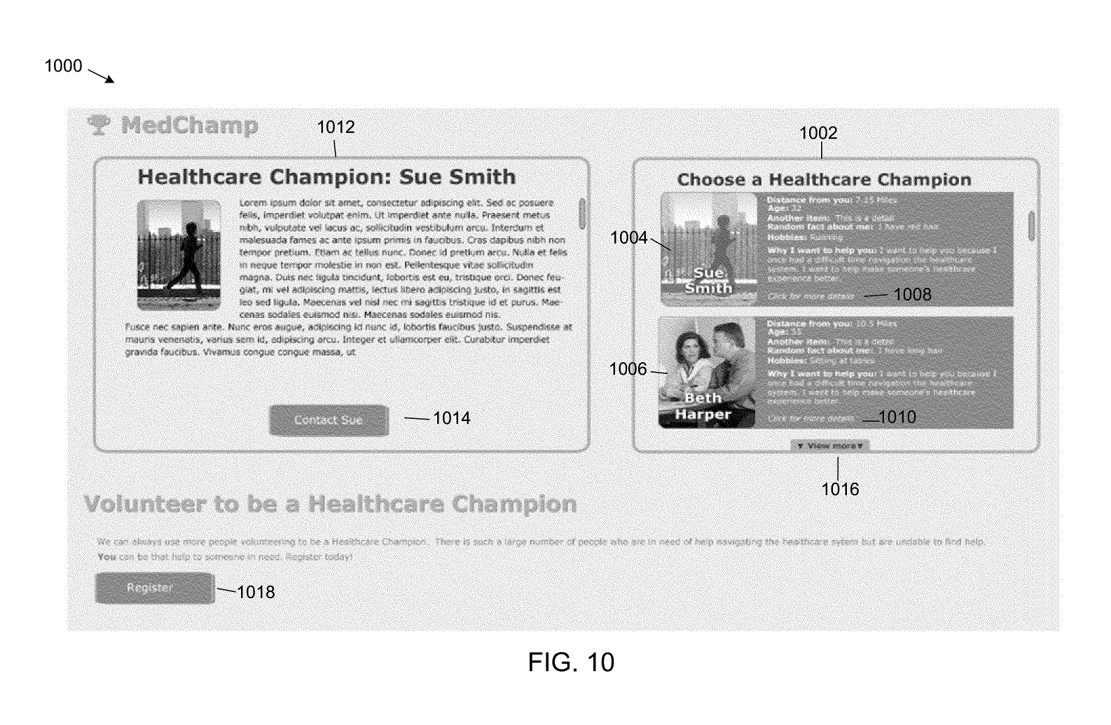

FIG. 10 shows an example user interface screen 1000 for choosing a healthcare champion. The user interface screen 1000 is displayed when the medchamp 616 icon is selected on the user interface screen 600. The user interface screen 1000 shows available healthcare champions 1002 from which to the user can choose. Summary information is shown for two available healthcare champions—Sue Smith 1004 and Beth Harper 1006. The example summary information includes a photo of the available healthcare champion, and other information including distance from the user, the age of the healthcare champion, certain facts that the healthcare champion wants to make known, such as hair color and hobbies and a reason as to why the healthcare champion wants to help you.

Also included are links 1008 and 1010 to obtain more information about the healthcare champion. For example when link 1008 is selected, detailed information 1012 is displayed regarding healthcare champion Sue Smith. In addition, link 1016 permits display of summary information for additional healthcare champions. The user interface screen 1000 also includes a section for volunteering to be a healthcare champion. The user can register to be a healthcare champion by clicking the register 1018 button.

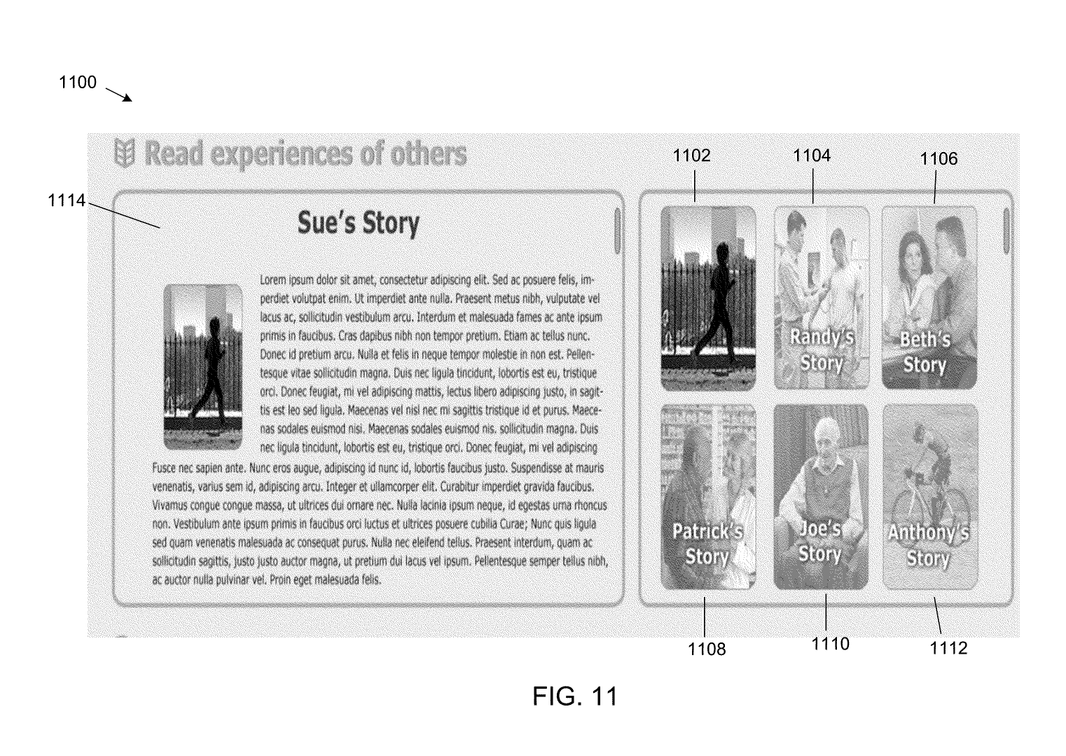

FIG. 11 shows an example user interface screen 1100 for reading about experiences of others. The user interface screen 1100 is displayed when the read/talk 610 icon is selected on the user interface screen 600. The user interface screen 1100 includes selectors for experience narrative for six people. Included are selector 1102 for Sue's story, selector 1104 for Randy's story, selector 1106 for Beth's story, selector 1108 for Patrick's story, selector 1110 for Joe's story and selector 1112 for Anthony's story. For the user interface screen 1100, each selector shows a photo for the person corresponding to the selector. The people for which the experience narratives are provided may include both healthcare champions and patients. When a person is selected, an experience narrative for the person is displayed. For example when selector 1102 is selected, the experience narrative 1114 for Sue's story is displayed. In other embodiments, selectors for more or fewer than six people are displayed.

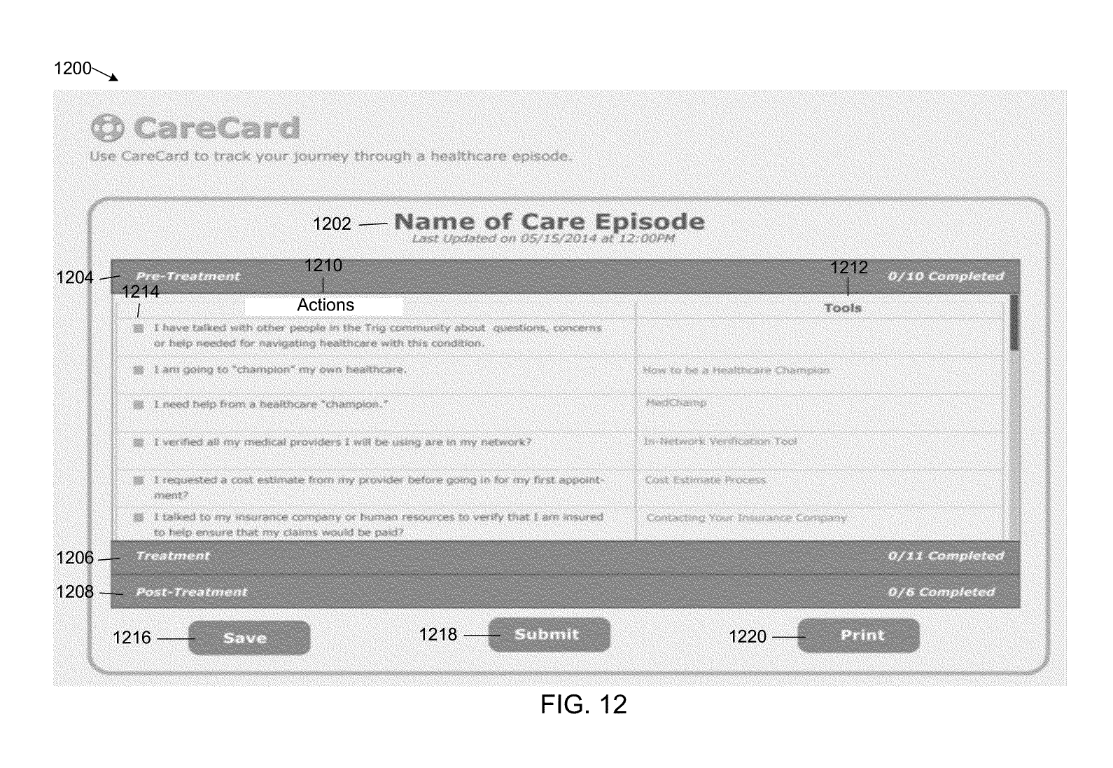

FIG. 12 shows an example user interface screen 1200 for a care card. The user interface screen 1200 is displayed when the carecard 620 icon is selected on the user interface screen 600. The example care card permits the user to track events of a health care episode. For the user interface screen 1200, a care card is displayed for a remediation action plan for the user. The example remediation action plan is based on the user's assessment results. The remediation action plan includes one or more actions that are suggested to the user to improve areas of knowledge for which the user may need help.

The example care card includes a title 1202 that provides a name for the health care episode. Also shown are sections for pre-treatment questions 1204, treatment questions 1206 and post-treatment questions 1208. Each section includes one or more actions 1210 associated with questions. One or more tools 1212 may be listed in a column adjacent to each action. The tools can be used to help the user implement the action. For example, for the action “I am going to champion my own healthcare,” a corresponding tool is “How to be a Healthcare Champion?” and for the action “I verified all my medical providers I will be using are in my network”, a corresponding tool is “In-Network Verification Tool.” Each listed tool provides a shortcut to the tool. For example, clicking on “How to be a Healthcare Champion?” causes the “How to be a Healthcare Champion?” tool to be displayed. See Appendix C. For some actions a tool may not be necessary, such as for “I have talked with other people about questions, concerns or help needed for navigating healthcare with this condition.

The example care card also includes a checkbox column 1214. When an action is completed the user can check a checkbox corresponding to the action. The care card also includes a save 1216 button, a submit 1218 button and a print 1220 button. The user can save changes made to the care card, submit the changes to web server 108 and print the care card.

As stated earlier herein, the user interface screen 600 also includes icons for mission 612, value 614 and store 626. Selection of the mission 612 icon displays a mission statement for the training and healthcare assessment system. Selection of the value 614 icon lists values promoted by the training and healthcare assessment system. Selection of the store 626 icon provides a display of selected healthcare system related products that can be purchased.

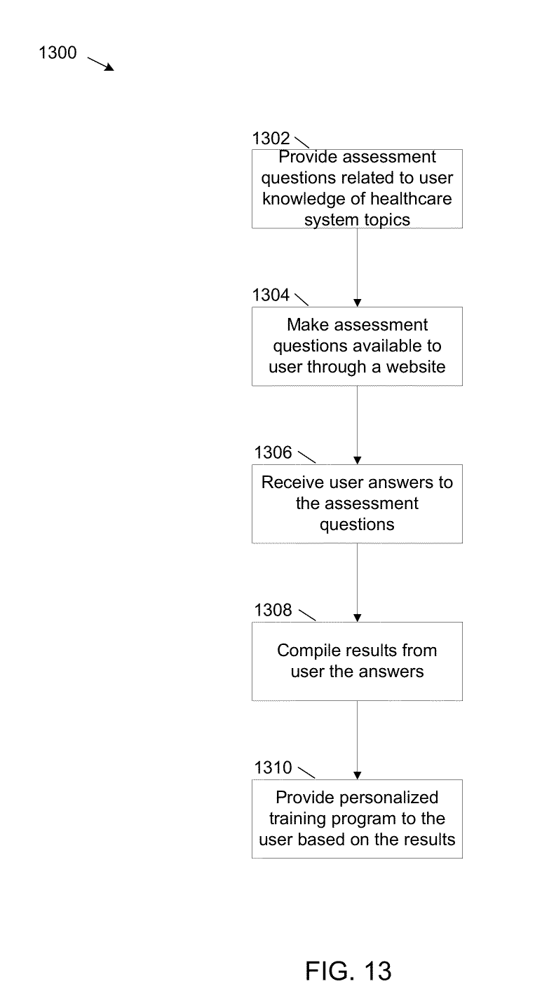

FIG. 13 shows an example flowchart for a method 1300 for assessing user knowledge regarding interacting with and navigating through the healthcare system.

At operation 1302, assessment questions regarding user knowledge of healthcare system topics are provided. The healthcare system topics are topics that educate a user on how to interact with the healthcare system before a healthcare event occurs, during a healthcare event and after a healthcare event.

At operation 1304, the assessment questions are made available to the user through a website. For method 1300, the user is the business user 116 on user computing device 102 and the website is the training system website hosted on web server 108. The healthcare system topics are topics from training system 112 on web server 108. The assessment questions are presented to the user via a user interface rendered on user computing device 102.

At operation 1306, user answers to the assessment questions are received at web server 108. At operation 1308, results are compiled from the answers to the assessment questions.

At operation 1310, a personalized training program is provided to the user based on the compiled results. The personalized training program identifies specific training modules that are recommended for the user to review. In an example embodiment, each training module is associated with an assessment question which the user answered incorrectly. The user is given options to review each training module in one of several ways—by reading content for the training module, by watching a video on the contents of the training module, by taking a quiz and by requesting an on-site group training session with a health risk consultant.

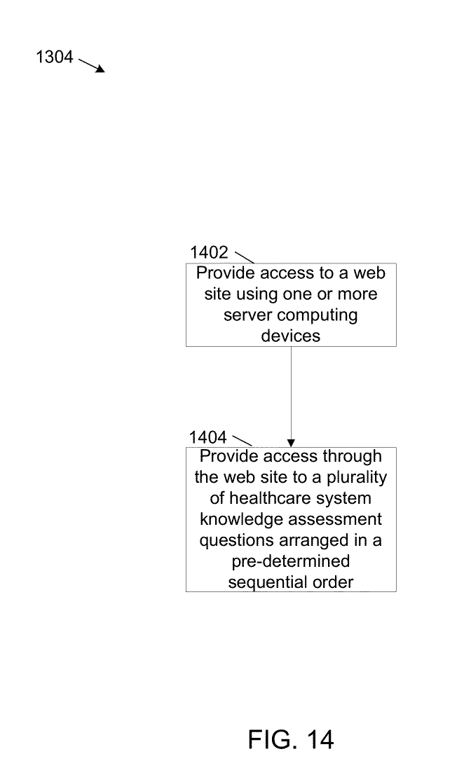

FIG. 14 shows an example flowchart for operation 1304 of FIG. 10. At operation 1402, access to a web site is provided using one or more server computers, for example web server 108. The access to the web site is typically from a user computer device, for example from user computing device 102 or user computing device 104.

At operation 1404, access is provided through the web site to a plurality of assessment questions. The assessment questions relate to user knowledge regarding user interaction with and navigation through the healthcare system. The plurality of assessment questions is arranged in a predetermined sequential order. An example of the predetermined sequential order is illustrated and described with reference to FIG. 14.

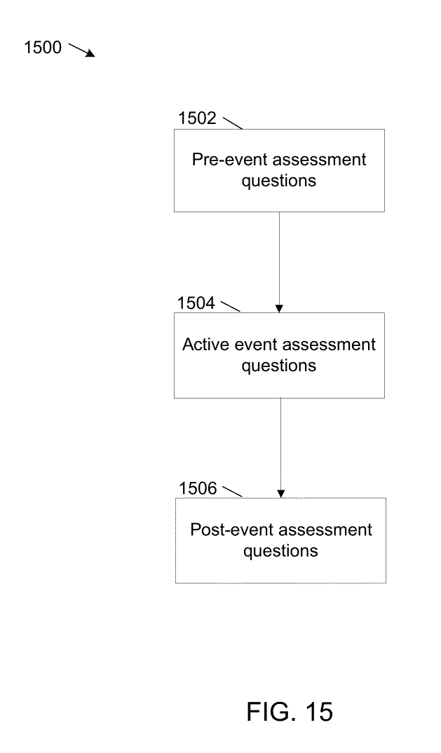

FIG. 15 shows an example of a predetermined sequential order of information provided by operation 1404 of FIG. 14. In this example, the sequential order includes pre-event assessment questions 1502, followed by active event assessment questions 1504, followed by post-event assessment questions 1506.

In some embodiments, the pre-event assessment questions 1502 include assessment questions on one or more educational topics that educate the user on how to interact with the healthcare system before a healthcare event occurs. Examples of the pre-event assessment questions 1502 include questions on how to fund healthcare when the healthcare event occurs and information on managing healthcare records generated during a healthcare event.

In some embodiments, the active event assessment questions 1504 include questions on one or more educational topics that educate the user on how to interact with the healthcare system during the occurrence of a healthcare event. Examples of the active event assessment questions 1504 include questions regarding assisting the user in verifying an illness, assisting the user in selecting treatment options, assisting the user in selecting a healthcare professional, assisting the user while the user is a patient and assisting the user when treatment ends. In some embodiments, the sequential order includes the active event assessment questions in order.

In some embodiments, the post-event assessment questions 1506 includes assessment questions on one or more educational topics that educate the user on how to interact with the healthcare system after one or more healthcare events has occurred. Examples of the post-event assessment questions 1506 include assessment questions on managing prescriptions and information on payment of a bill for the healthcare event.

In some embodiments the sequential order is defined by a web page that presents the assessment questions in the sequential order. Each of the assessment questions is presented on a separate page of the web site. In some embodiments the predetermined sequential order provides a structure for the assessment questions in which the assessment questions presented later in the sequential order builds on the assessment questions presented earlier in the sequential order. In some embodiments the sequential order is substantially chronological with the order in which a user is likely to utilize the educational topics corresponding to the assessment questions. For example, in some embodiments the pre-event assessment questions provides questions that assess user knowledge regarding educational topics pertinent to issues before a healthcare event occurs, while active event information provides assessment questions regarding to educational topics pertinent to issues once the healthcare event has occurred, and the post-event assessment questions provides information that assesses user knowledge regarding educational topics pertinent to issues after the healthcare event has occurred. Typically, the web site requires that the assessment questions be viewed in the sequential order in which it is arranged, such as by not permitting access to subsequent assessment questions until prior assessment questions have been accessed and answered.

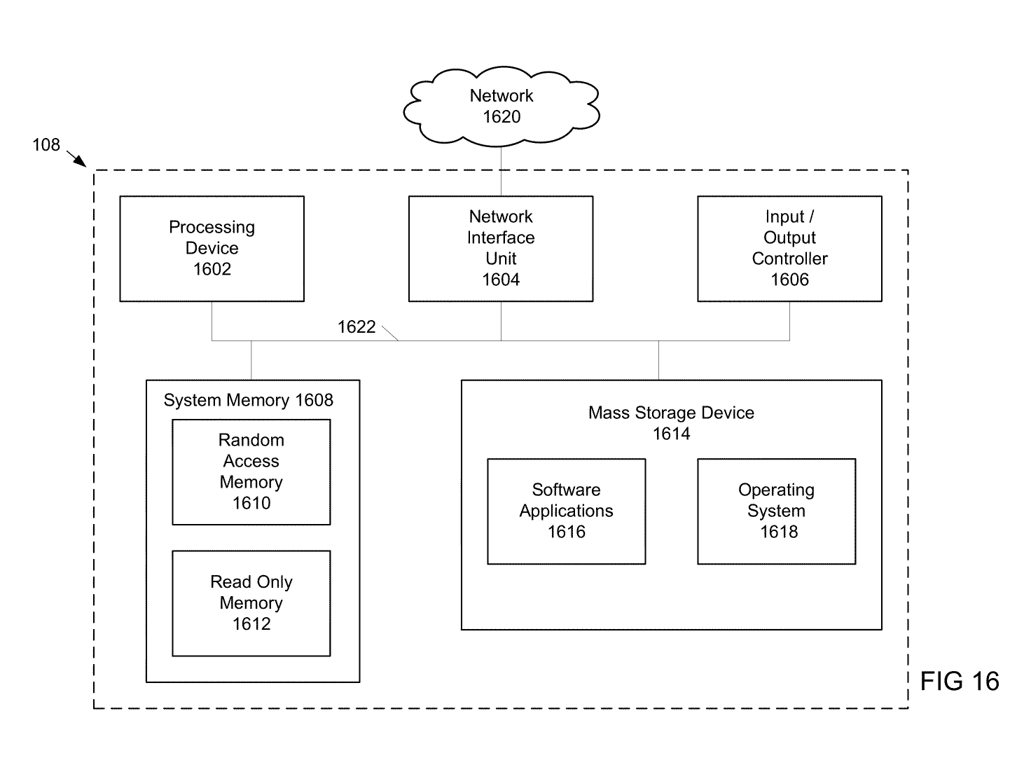

As illustrated in the example of FIG. 16, the web server 108 includes at least one processing device 1602 (such as a central processing unit) and a computer readable storage device. Although described in terms of the web server 108, the computing device depicted in FIG. 16 is also an example of any one or more of the other computing devices described herein (including, for example, the user computing devices 102 and 104, computing devices utilized within the healthcare system 122, and computing devices utilized by the healthcare consultants 120, all shown in FIG. 1), and therefore the structure of such devices will not be separately repeated herein.

In this example, the web server 108 includes a processing device 1602, a system memory 1608, and a system bus 1620 that couples the system memory 1608 to the processing device 1602. The system memory 1608 includes a random access memory (“RAM”) 1610 and a read-only memory (“ROM”) 1612. A basic input/output system contains the basic routines that help to transfer information between elements within the web server 108, such as during startup, is stored in the ROM 1612. The web server 108 further includes a mass storage device 1614. The mass storage device 1614 is able to store software instructions and data.

The mass storage device 1614 is connected to the processing device 1602 through a mass storage controller (not shown) connected to the bus 1620. The mass storage device 1614 and its associated computer-readable data storage media provide non-volatile, non-transitory storage for the web server 108. Although the description of computer-readable data storage media contained herein refers to a mass storage device, such as a hard disk or solid state disk, it should be appreciated by those skilled in the art that computer-readable data storage media can be and are limited to any available non-transitory, physical device or article of manufacture from which the processing device 1602 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the web server 108. A computer readable storage device is a non-transitory physical device including at least one computer-readable data storage medium.

According to various embodiments of the invention, the web server 108 may operate in a networked environment using logical connections to remote network devices through the network 1618, such as a local network, the Internet, or another type of network. The web server 108 may connect to the network 1618 through a network interface unit 1604 connected to the bus 1620. It should be appreciated that the network interface unit 1604 may also be utilized to connect to other types of networks and remote computing systems. The web server 108 also includes an input/output controller 1606 for receiving and processing input from a number of other devices, including a keyboard, a mouse, a touch user interface display screen, or another type of input device. Similarly, the input/output controller 1606 may provide output to a touch user interface display screen, a printer, or other type of output device.

As mentioned briefly above, the mass storage device 1614 and the RAM 1610 of the web server 108 can store software instructions and data. The software instructions include an operating system 1616 suitable for controlling the operation of the web server 108. The mass storage device 1614 and/or the RAM 1610 also store software instructions, that when executed by the processing device 1602, cause the web server 108 to provide the functionality of the web server 108 discussed in this document. For example, the mass storage device 1614 and/or the RAM 1610 can store software instructions that, when executed by the processing device 1602, cause the web server 108 to communicate web page data to user computing device 102 or user computing device 104.

Other example physical components of the web server 108 are possible. In general, the web server 108 supports a computing platform that provides capabilities for a standardized interface (for example USB), a standardized wireless communication interface (for example Bluetooth or NFC) and a user interface.

Although the present disclosure refers to example implementations involving a web server that generates a web site, such as can be accessed through a web browser software application operating on a computing device, other embodiments are implemented in other ways. For example, some embodiments include a software application operating on a computing device which presents the information described herein. As another example, some embodiments are implemented as a software app operating on a computing device, such as a smartphone or a tablet computer.

Some embodiments are implemented involving a cloud-based data storage system or a cloud-based server computing device.

References to web page elements are also provided by way of example and not of limitation. For example, the links and buttons described herein can be implemented as another form of selectable control, including touch sensitive elements or software controls. Inputs can be provided by a user utilizing any suitable input technology, such as a pointer device, a touch sensitive display, voice recognition technology, and the like.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of accessing user knowledge of a healthcare system, the method comprising:
providing access to a web site using one or more server computing devices;
providing access to a plurality of assessment questions through the web site, the plurality of assessment questions relating to user knowledge regarding interaction with and navigation through a healthcare system, the plurality of assessment questions being arranged in a pre-determined sequential order including, in order:
pre-event assessment questions including assessment questions on one or more educational topics that assess the knowledge of the user on how to interact with the healthcare system before a healthcare event occurs;
active event assessment questions including assessment questions on one or more educational topics that assess the knowledge of the user on how to interact with the healthcare system during the occurrence of a healthcare event; and
post-event assessment questions including assessment questions on one or more educational topics that assess the knowledge of the user on how to interact with the healthcare system after one or more healthcare events has occurred.

2. The method of claim 1, wherein the pre-event assessment questions includes questions on financial information on how to fund healthcare when the healthcare event occurs, and questions on managing healthcare records generated during a healthcare event.

3. The method of claim 1, wherein the active event assessment questions includes:
questions relating to assisting the user in verifying an illness;
questions relating to assisting the user in selecting treatment options;
questions relating to assisting the user in selecting a healthcare professional;
questions relating to assisting the user while the user is a patient; and
questions relating to assisting the user when treatment ends.

4. The method of claim 1, wherein the post-event assessment questions includes assessment questions on managing prescriptions and information on payment of a bill for the healthcare event.

5. The method of claim 1, wherein the healthcare system includes policies and procedures defined by health insurance companies and policies and procedures defined by healthcare administrators.

6. The method of claim 1, wherein the sequential order is defined by a web page that presents links to the assessment questions arranged in the sequential order.

7. The method of claim 6, wherein the links prevent a next sequential question to be displayed until an answer is selected for a currently displayed question.

8. The method of claim 1, further comprising providing access to a plurality of educational topics through the web site, the plurality of educational topics relating to user interaction with and navigation through the health care system.

9. The method of claim 8, wherein each assessment question is related to one or more of the plurality of educational topics.

10. The method of claim 8, wherein the pre-event assessment questions are related to a first group of the plurality of educational topics, the active event assessment questions are related to a second group of the plurality of educational topics and the post-event assessment questions are related to a third group of the plurality of educational topics.

11. The method of claim 1, further comprising:
scoring answers to the assessment questions; and
based on a user's score providing a personalized training plan for the user.

12. The method of claim 11, further comprising:
determining the user's overall score for all assessment questions;
determining the user's score for the pre-event assessment questions;
determining the user's score for the active event assessment questions;
determining the user's score for the post-event assessment questions.

13. The method of claim 11, wherein providing the personalized training plan for the user comprises providing a recommendation for one or more educational topics for the user to review, the recommendation of the one or more educational topics being based on one or more of the user's overall score, the user's score for the active event assessment questions and the user's score for the post-event assessment questions.

14. The method of claim 11, further comprising permitting the user to select whether the personalized training plan includes live training sessions with a health risk consultant.

15. The method of claim 11, further comprising:
providing one or more online quizzes to assess the user's understanding of the one or more educational topics in the personalized training plan; and
providing access to the quizzes through the website.

16. A method for accessing knowledge of a healthcare system for employees of a business, the method comprising:
providing healthcare system assessment questions to the employees in a predetermined order, the healthcare system assessment questions being provided from a server computer through a website;
compiling results from the assessment questions;
providing a personalized training plan to the employees based on the results;
making content available through the website to train the employees on healthcare system topics associated with the personalized training plan;
providing quizzes related to the healthcare system topics;
compiling results from the quizzes; and
using the results of the quizzes to evaluate the effectiveness of the personalized training plans.

17. The method of claim 16, wherein the healthcare system assessment questions are arranged in a pre-determined sequential order including, in order:
pre-event information, including assessment questions on one or more healthcare system topics that educate employees on how to interact with the healthcare system before a healthcare event occurs;
active event assessment questions including assessment questions on one or more educational topics that educate the employees on how to interact with the healthcare system during the occurrence of a healthcare event; and
post-event assessment questions including assessment questions on one or more educational topics that educate the employees on how to interact with the healthcare system after one or more healthcare events has occurred.

18. The method of claim 16, providing the personalized training plan to the employees comprises identifying one or more educational topics for the employee to review through the web site.

19. The method of claim 18, further comprising identifying one or more educational topics based on an overall score for the assessment questions and based on one or more of a score for the pre-event assessment questions, the active event assessment questions and the post-event assessment questions.

20. A server computer comprising:
a processing unit; and
memory, the memory storing instructions that, when executed by the processing unit, cause the server computer to:
host a web site that provides a plurality of educational topics and that provides a plurality of assessment questions relating to the educational topics;
provide access to the plurality of assessment questions through the web site, the plurality of assessment questions relating to user interaction with and navigation through a healthcare system, the plurality of assessment questions being arranged in a pre-determined sequential order including, in order:
pre-event assessment questions including assessment questions on one or more educational topics that educate the user on how to interact with the healthcare system before a healthcare event occurs, the pre-event assessment questions including questions on financial information on how to fund healthcare when the healthcare event occurs, and questions on managing healthcare records generated during a healthcare event;
active event assessment questions including assessment questions on one or more educational topics that educate the user on how to interact with the healthcare system during the occurrence of a healthcare event, the active event assessment questions including:
questions relating to assist the user in verifying an illness;
questions relating to assist the user in selecting treatment options;
questions relating to assist the user in selecting a healthcare professional;
questions relating to assist the user while the user is a patient;
and questions relating to assist the user when treatment ends; and
post-event information including assessment questions on one or more educational topics that educate the user on how to interact with the healthcare system after one or more healthcare events has occurred, the post-event assessment questions including questions on managing prescriptions and information on payment of a bill for the healthcare event;
compile results from the assessment questions;
provide a summary of the results to the user through the website;
provide a personalized training plan for the user based on the compiled results, the personalized training plan including a recommendation of one or more of the educational topics for the user to review, the recommendation of the one or more educational topics for the user to review being based on the user's score;
provide quizzes related to each of the recommended educational topics; and
provide access to the quizzes through the website; and
compile results from the quizzes.
